(19) United States
(12) Patent Application Publication
(10) Pub. No.: US 2013/0007736 A1
(43) Pub. Date: Jan. 3, 2013

(54) INFORMATION PROCESSING APPARATUS, METHOD OF PROCESSING INFORMATION AND STORAGE MEDIUM

(76) Inventor: Hiroshi Nakajima, Nishitokyo-shi (JP)

(21) Appl. No.: 13/402,684

(22) Filed: Feb. 22, 2012

(30) Foreign Application Priority Data
Jun. 30, 2011 (JP) 2011-145955

(51) Int. Cl. G06F 9/455

(52) U.S. Cl. 718/1

(57) ABSTRACT

According to one embodiment, an information processing apparatus includes a virtualization engine which constructs a virtual machine. The virtualization engine includes a virtual disk file generation module and a data transmission module. The virtual disk file generation module generates a virtual disk file for a virtual disk to be constructed on the virtual machine. The virtual disk file has a data structure in which difference data is stored as a layer in time series. The data transmission module executes data transmission in order from difference data in an upper layer which is new in time series, when taking synchronization of the user data in the virtual disk file between a file server and the virtual machine.

### CROSS-REFERENCE TO RELATED APPLICATIONS

This application is based upon and claims the benefit of priority from prior Japanese Patent Application No. 2011-145955, filed Jun. 30, 2011, the entire contents of which are incorporated herein by reference.

### FIELD

Embodiments described herein relate generally to an information processing technique suitable for an information processing apparatus to be applied to a network system for managing a plurality of clients by a server.

### BACKGROUND

In recent years, information technology (IT) has been applied to business in many enterprises. In enterprises like this, workers work by using personal computers (PCs) lent from, for example, the companies. Also, local area networks (LANs) are installed in many offices in order to share resources including data by interconnecting these PCs.

On the other hand, the problem that an employee leaks confidential information of an enterprise via a PC used in business sometimes arises. Accordingly, various mechanisms for strengthening the security concerning PCs used in business in offices have been proposed.

For example, a thin client is a computer including only a communication device, a keyboard for a user interface, and a display device, in addition to a central processing unit (CPU) and main memory, and a server (thin-client server) connected across a network manages data and various programs including an operating system. That is, since the thin client used by the user stores no data, it is possible to prevent an information leak and strengthen the security.

A recent operating system manages user data called a profile unique to each user, thereby allowing each login user to, for example, set the layout of a basic screen image called a desktop or the like. Some thin-client servers can construct a plurality of virtual machines as virtual hardware environments for operating various programs including an operating system, and allocate a thin client to each virtual machine. This thin-client server supplies, to an operating system running on each virtual machine, user data for a user using a thin client allocated to the virtual machine.

Consequently, the operating system running on the virtual machine forms a screen image for the user, and the image data is transferred to the thin client and presented to the user. Note that in the following description, the work environment of each user, which is constructed on a virtual machine by combining various programs including an operating system and the user data unique to the user, will sometimes be called a virtual desktop environment.

Assume that a PC including an external memory such as a hard disk drive (HDD) is to be used as a thin client. More specifically, assume that a module including a function of constructing a virtual machine on a PC and a function of managing various programs including an operating system running on the virtual machine and input/output data of the various programs by using, for example, a management server or file server connected across a network is to be installed in a PC. That is, a mechanism by which no data is stored on a PC used in business by a worker or the like is constructed on the PC. Note that the purpose of the management of the various programs by the management server or the like is operation management, so the various programs can be installed on a PC.

In this case, a file server or the like manages the user data unique to each user, which is used by an operating system (running on the virtual machine) at the login. Whenever logging in to the PC, therefore, the PC must acquire the user data unique to the user from the file server. Based on this acquired user data, the operating system constructs a virtual desktop environment.

Accordingly, when the volume of this user data increases because the user variously customizes the layout of the basic screen image, for example, lays out a large number of objects (icons) called shortcuts or the like on the desktop, the time before the completion of login may prolong if the file server is in a high-load state or the network band between the PC and file server is narrow.

Furthermore, when the layout of the basic screen image is customized, the time before the completion of logout may prolong because updated user data must be reflected on the file server during logout.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing a configuration of a network system to which an information processing apparatus of an embodiment is applied.

FIG. 2 is an exemplary view showing the system configuration of the information processing apparatus of the embodiment.

FIG. 3 is an exemplary conceptual view for explaining the principle of increasing the efficiency of data transmission between the information processing apparatus of the embodiment and a server.

FIG. 4 is an exemplary view showing the data structure of a virtual disk file for a virtual disk to be generated by the information processing apparatus of the embodiment.

### DETAILED DESCRIPTION

Various embodiments will be described hereinafter with reference to the accompanying drawings.

In general, according to one embodiment, an information processing apparatus includes a communication module and a virtualization engine. The virtualization engine is configured to construct a virtual machine as a virtual hardware environment for running various programs including an operating system. The virtualization engine includes a virtual disk file generation module and a data transmission module. The virtual disk file generation module is configured to generate a virtual disk file for a virtual disk to be constructed on the virtual machine in order to manage user data unique to each user by a file server connected via the communication module and cause the operating system running on the virtual machine to recognize the user data managed by the file server as data stored in a disk on the virtual machine. The user data includes setting information of the operating system running on the virtual machine. The virtual disk file has a data structure in which difference data is stored as a layer in time series. The data transmission module is configured to execute data transmission in order from difference data in an upper layer which is new in time series, when taking synchronization of the user data in the virtual disk file between the file server and the virtual machine.

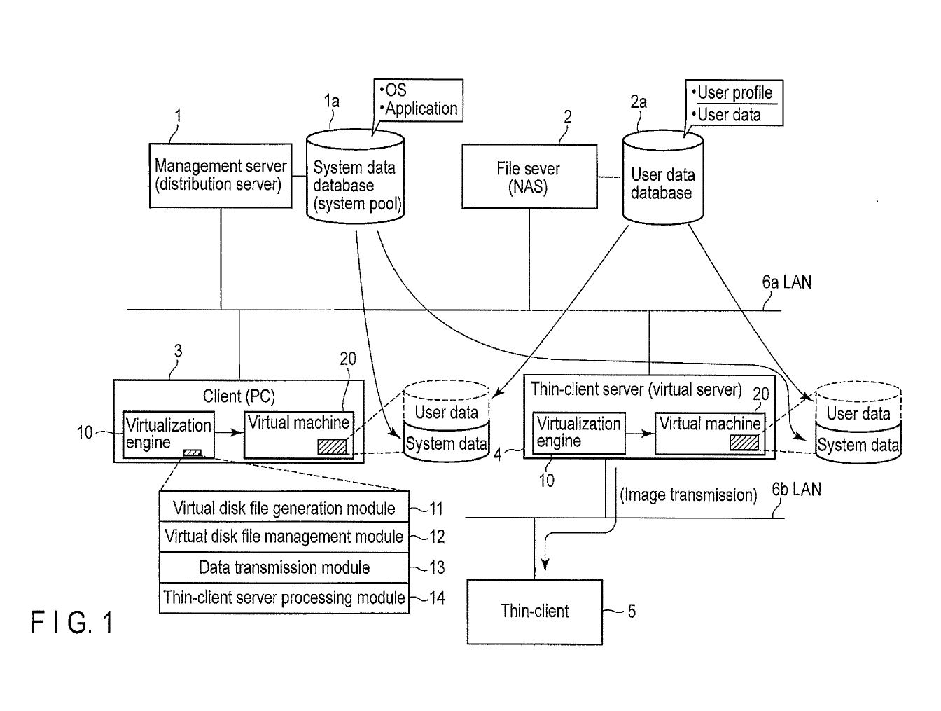

FIG. 1 is an exemplary view showing a configuration of a network system to which an information processing apparatus (a client (PC) 3 or thin-client server 4) of this embodiment is applied. This network system is, for example, a network system constructed for business by an enterprise, in which each worker (user) works by using the client 3 or a thin client 5. Note that FIG. 1 shows one client 3 and one thin client 5 for the sake of simplicity, but a plurality of clients 3 and a plurality of thin clients 5 generally exist, and each user can start working by using his or her own desktop environment regardless of the client 3 or thin client 5 he or she uses. Note also that FIG. 1 shows both the client 3 and the thin-client server 4 and thin client 5. However, it is naturally possible to construct the network system such that only the client 3 exists or only the thin-client server 4 and thin client 5 exist.

In this network system as shown in FIG. 1, a management server 1, a file server 2, the client 3, and the thin-client server 4 are connected to a LAN 6a, and the thin-client server 4 and thin client 5 are connected to a LAN 6b. Note that FIG. 1 shows the two LANs 6a and 6b to make the logical hierarchical relationship easy to understand. However, these LANs may also be installed as a physically single LAN.

First, an operation when the user uses the client 3 will be explained.

The client 3 is, for example, a notebook PC, and includes a CPU 101, main memory 102, external storage device 103, input device 104, display device 105, and communication device 106 as shown in FIG. 2.

The CPU 101 loads various programs including an operating system into the main memory 102 from the external storage device 103, and executes the loaded programs. A virtualization engine 10 as a program for constructing a virtual machine 20 is installed in the client 3. The virtual machine 20 is a virtual hardware environment for running the various programs including the operating system to be used by the user. The virtualization engine 10 can construct a plurality of virtual machines 20 on one client 3. Also, the virtualization engine 10 includes a virtual disk file generation module 11, virtual disk file management module 12, data transmission module 13, and thin-client server processing module 14 (to be described later).

When activated, the client 3 loads a first operating system into the main memory 102 from the external storage device 103 allocated as a boot disk, and activates the first operating system. The first operating system is an operating system to be used to activate the virtualization engine 10 defined as a resident program. That is, the virtualization engine 10 is activated under the control of the first operating system at the same time the client 3 is activated.

Image data (system data) for a virtual desktop environment to be constructed on the virtual machine 20 constructed on the client 3 is stored as a file in a system data database 1a of the management server 1 connected by communication executed across the LAN 6a by the communication device 106. This image data contains a second operating system, and various application programs that run under the control of the second operating system. The image data is generated by, for example, constructing a virtual machine on the management server 1, and installing the second operating system and various application programs on this virtual machine. The second operating system and various application programs are common programs that each user uses to work.

The activated virtualization engine 10 constructs the virtual desktop environment of each user on the virtual machine 20 constructed on the client 3, by using the image data (and user data (to be described later) unique to the user). This image data is acquired from the management server 1 and stored in the external storage device 103 by the virtualization engine 10 when, for example, the client 3 is initially activated. After that, the virtualization engine 10 suitably checks whether the image data stored in the external storage device 103 is the latest image data stored in the system data database 1a. If the stored image data is not the latest image data, the virtualization engine 10 acquires the latest image data (an updating program for updating the image data to the latest image data) from the management server 1.

It is also possible to distribute the latest image data from the management server 1 to the client 3, when the image data is updated. Since the virtualization engine 10 constructs the virtual machine 20 on the client 3 by using the image data stored in the system data database 1a of the management server 1, it is possible to comprehensively manage the work environment of the client 3, which the user uses in business (operation management). For example, if individual departments in a company use partially different application programs, the operation management can be performed by forming image data for each department, or preparing difference data for each department.

As described above, when the client 3 is activated, the first operating system activates the virtualization engine 10, and the second operating system is activated on the virtual machine 20 constructed by the virtualization engine 10. The second operating system causes the display device 105 to present a graphical user interface (GUI) for the user to log in. In response to the presentation of this GUI, the user enters a user identification (ID) and password by using the input device 104. The second operating system executes a login procedure including user authentication by using the entered user ID and password, and presents a basic screen image called a desktop or the like on the display device 105. A plurality of virtual machines 20 constructed by the virtualization engine 10 may use different second operating systems.

The virtualization engine 10 also includes a function of preventing data used by the user from being stored in the client 3. The virtualization engine 10 generates a virtual disk file on the main memory 102 or external storage device 103 for each virtual machine 20. The virtual disk file generation module 11 is a module for generating this virtual disk file. Then, the virtualization engine 10 causes the second operating system running on the virtual machine 20 to recognize the generated virtual disk file as a disk. That is, the virtualization engine 10 constructs a virtual disk on the virtual machine 20.

For example, when an application program running under the control of the second operating system writes data on the virtual disk on the virtual machine 20 (via the second operating system), the data is stored in the virtual disk file on the main memory 102 or external storage device 103. The virtual disk file generated on the main memory 102 or external storage device 103 is temporary, and the virtualization engine 10 manages the data stored in this virtual disk file by the file server 2 connected by communication executed across the LAN 6a by the communication device 106.

That is, data written on the virtual disk by the various programs including the second operating system running on the virtual machine 20 are actually saved by a user data database 2a of the file server 2 connected across the LAN 6a. Also, data to be read from the virtual disk by the various programs actually exist in the user data database 2a of the file server 2. In other words, data used by the user may temporarily exit on the client 3 but is never saved in it. The data transmission module 13 is a module for performing data transmission required to obtain data synchronization between the virtual disk file and file server 2.

During logout, the virtualization engine 10 transmits, to the file server 2, data written on the virtual disk (the virtual disk file in the external storage device 103) on the virtual machine 20. The virtualization engine 10 deletes, from the external storage device 103, the data transmitted to the file server 2 during logout. Furthermore, when detecting that the client 3 is disconnected from the LAN 6a, the virtualization engine 10 inhibits access to the virtual disk from the various programs including the second operating system running on the virtual machine 20. For example, the virtualization engine 10 eliminates the virtual disk from the virtual machine 20. This protects data in the virtual disk file from being used outside this network system. That is, a high security equal to that of the thin client 5 is achieved.

When executing the above described login procedure and presenting the basic screen image called a desktop or the like on the display device 105, the second operating system reads the user data called a profile or the like unique to the user. Based on the read user data, the second operating system presents the basic screen image for the login user on the display device 105. For example, when an object (icon) called a shortcut or the like for activating a given program is placed on the basic screen image, the program can easily be activated by simply operating the icon. The layout of shortcuts on the basic screen image and the like are managed as the user data. Accordingly, even when users A and B use the same client 3, the basic screen image presented on the display device 105 when user A logs in can be made different from that when user B logs in.

The virtualization engine 10 saves the user data called a profile or the like unique to the user (which is managed by the second operating system) in the user data database 2a of the file server 2. To respond to a read request from the second operating system during login, the user data must be transmitted from the user data database 2a of the file server 2 to the virtual disk (the virtual disk file in the external storage device 103) on the virtual machine 20.

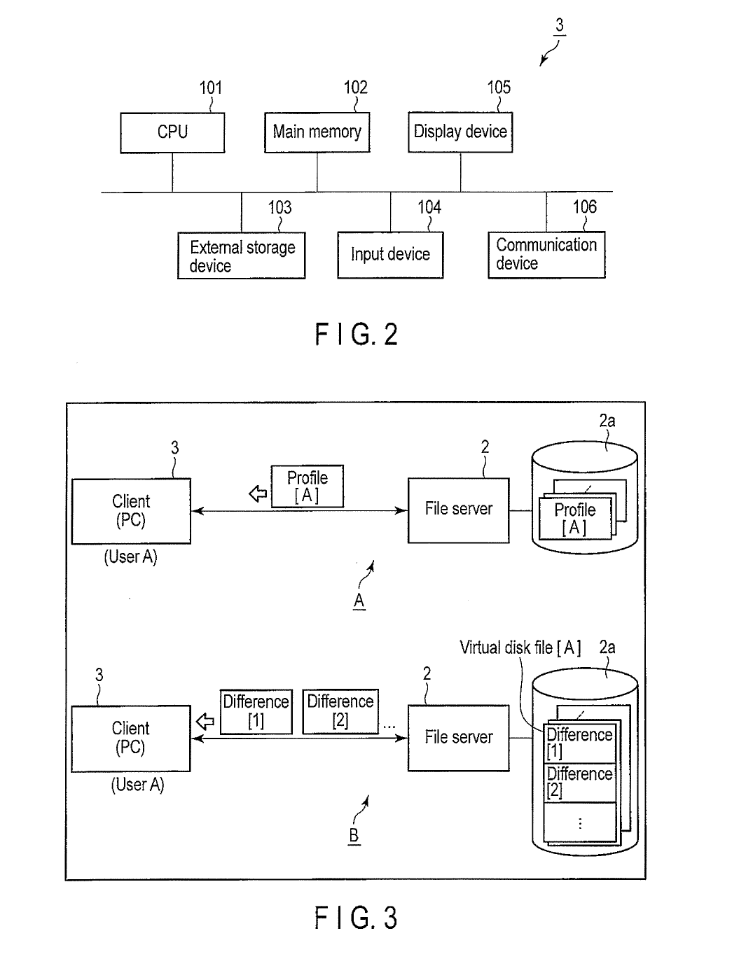

As indicated by “A” in FIG. 3, data transfer between the client 3 and file server 2 is normally executed for each file requested as a read target by any of the various programs running on the virtual machine 20. Accordingly, if the volume of the user data increases because, for example, the user has largely customized the basic screen image to make it easier to use, it sometimes takes a long time to transmit the user data from the file serve 2 to the client 3. After the login operation, therefore, the user may have to wait for a long time before the client 3 becomes usable.

To prevent this, the information processing apparatus of this embodiment makes it possible to efficiently transmit the user data (acquire the synchronization of the user data) between the file server 2 and client 3. This feature will be described in detail below.

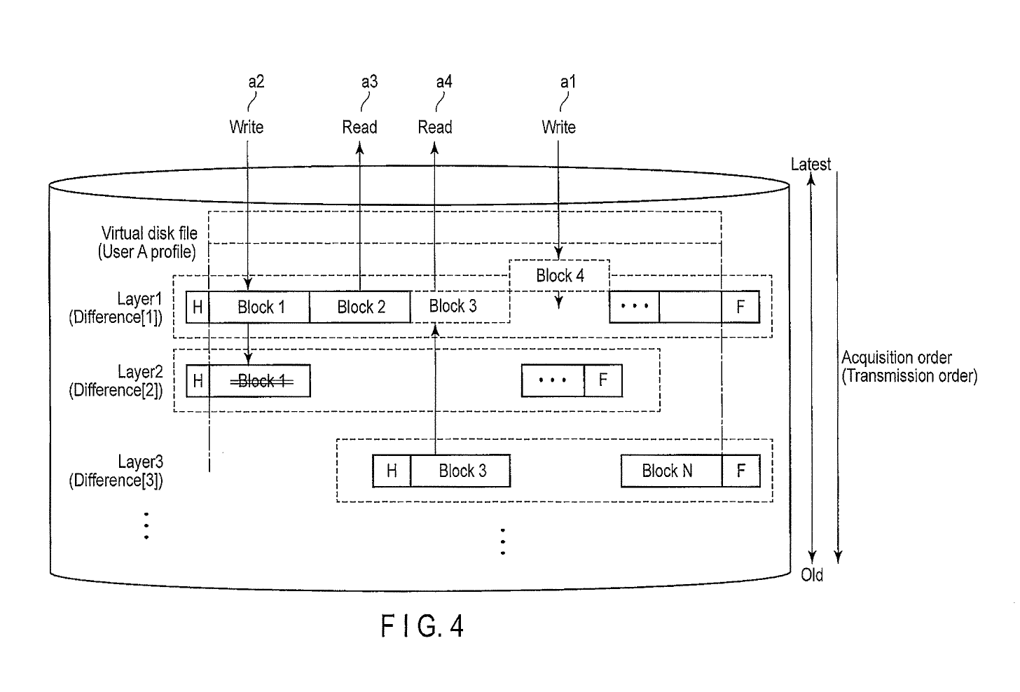

To efficiently transmit the user data between the file server 2 and client 3, the virtualization engine 10 generates, on the main memory 102, a virtual disk file for constructing a virtual disk on the virtual machine 20, as a file having a data structure as shown in FIG. 4. If a free space unused by the second operating system and remaining in the main memory 102 is small, the virtual disk file may also be generated on the external storage device 103 by selecting a security level by the manager. The virtualization engine 10 generates this virtual disk file for each user who logs in to the second operating system running on the virtual machine 20. That is, when a user who logs in to the second operating system running on the virtual machine 20 has changed to another user, the virtualization engine 10 switches the virtual disk files for virtual disks to be constructed on the virtual machine 20.

As shown in FIG. 4, the virtual disk file has a data structure in which difference data are stored as layers in time series. Each layer is obtained by gathering a plurality of blocks containing data into one block file. That is, the virtual disk file exists as a set of a plurality of block files. The start or end of each block file has a header or footer, and information indicating a sector of the virtual disk to which data of each block corresponds is stored as, for example, a bitmap in the header or footer.

When any of the various programs including the second operating system running on the virtual machine 20 writes data, the virtualization engine 10 places this data in the uppermost layer (a1 and a2 in FIG. 4). When no write target block exists in the uppermost layer (a1 in FIG. 4) because, for example, new data is to be written, the virtualization engine 10 secures a block for storing the data, writes the data in the block, and rewrites a bitmap to be stored in the header (H) or footer (F) of the uppermost layer (block file). On the other hand, when a write target block exists in the uppermost layer (a2 in FIG. 4) because data for update is to be written, the virtualization engine 10 writes the data in this block existing in the uppermost layer. Also, if a block containing update target data exists in a lower layer, the virtualization engine 10 may also invalidate or delete the block. When the block is not deleted, the logical disk volume increases. Even if the uppermost layer breaks, however, the state immediately before the uppermost layer is generated can be restored by removing the layer, although the latest written data is lost.

When any of the various programs including the second operating system running on the virtual machine 20 reads data, a block containing the data normally exists in a given layer. If the block exists in the uppermost layer (a3 in FIG. 4), the virtualization engine 10 reads the data from the block. On the other hand, if the block exists in a lower layer (a4 in FIG. 4), the virtualization engine 10 reads the data from the block, and at the same time copies the block to the uppermost layer.

Due to this function of the virtualization engine 10, a block containing data recently accessed by any of the various programs including the second operating system running on the virtual machine 20 exists in the block file of the uppermost layer. The virtual disk file management module 12 is a module for managing the update of the virtual disk file caused by data access by the various programs including the second operating system running on the virtual machine 20.

Based on the data structure of the virtual disk file and the virtual disk file updating procedure performed by the virtualization engine 10, user data transmission between the file server 2 and client 3 will be explained below.

When a user logs in by entering the user ID and password in response to the presentation of the GUI by the second operating system running on the virtual machine 20, the virtualization engine 10 constructs a virtual disk for the user on the virtual machine 20. That is, the virtualization engine 10 generates a virtual disk file for the user in the external storage device 103. This virtual disk file is generated by acquiring the virtual disk file stored in the user data database 2a from the file server 2, and storing the virtual disk file in the main memory 102 or external storage device 103. In this process, the virtualization engine 10 acquires block files in order from that of the uppermost layer as indicated by “B” in FIG. 3. More specifically, the virtualization engine 10 requests the file server 2 to first transmit the block file of the uppermost layer from among a plurality of block files forming the virtual disk file.

Upon receiving this block file of the uppermost layer, the virtualization engine 10 causes the second operating system running on the virtual machine 20 to recognize the virtual disk file (the transmission of which from the file server 2 is only partially complete) as a disk. Access for login is almost performed for data used last time, so the data exists in the uppermost layer. Therefore, the login procedure can be completed in the uppermost layer alone. By taking the load on the client 3 into account, the virtualization engine 10 starts acquiring the block files of lower layers from the file server 2 at, for example, a predetermined interval after the completion of the login procedure. That is, the information processing apparatus of this embodiment achieves efficient data transmission (data synchronization acquisition) by which data highly likely to be accessed is transmitted earlier, and data less likely to be accessed is transmitted later. This makes it possible to largely shorten the time before the client 3 becomes usable after the login operation.

Note that when the file server 2 requests the read of data existing in a lower layer the transmission of which to the client 3 is not complete, the virtualization engine 10 temporarily stops the reception of the data read request. When the block file of this lower layer is loaded into the client 3, the virtualization engine 10 cancels the state in which the reception of the read request for the data is stopped. When all the block files are completely transmitted, no unreadable data exists.

On the other hand, during logout, the block file of a layer in which update has occurred need only be transmitted to the file server 2. This makes it possible to shorten the time before the completion of logout as well. Note that if a block containing update target data exists in a lower layer when data write for update is performed, the virtualization engine 10 invalidates or deletes this block of the lower layer as described above. When the block is deleted, the size of the corresponding lower layer (block file) can be decreased, so the time required to transmit this block file to the file server 2 can be shortened. The invalidation of the block is performed by attaching attribute information (typically, a flag) indicating that the block is invalidated. Since the size of the block file of the corresponding lower layer remains unchanged in this case, the time required to transmit the block file to the file server 2 does not shorten. However, data before the update remains as a log, so it is possible to, for example, reproduce the state of the virtual disk at a given time in the past.

When the read of data existing in a lower layer is requested, the virtualization engine 10 copies the data to the uppermost layer as described previously. As long as the contents are the same, no mismatching occurs regardless of a layer from which the data is read. That is, the same data can exist in a plurality of layers without any problem. By suppressing the update of a lower layer (block file), the virtualization engine 10 decreases the number of block files to be transmitted to the file server 2 during logout.

Next, an operation when the user uses the thin client 5 will be explained.

The thin client 5 is, for example, a computer having an arrangement in which the external storage device 103 is omitted from the arrangement of the client 3 shown in FIG. 2.

As described earlier, the virtualization engine 10 can construct a plurality of virtual machines 20 on one client 3. The virtualization engine 10 is installed in the thin-client server 4 for managing the thin client 5 as well. Note that the thin-client server 4 is, for example, a computer having the same arrangement as that of the client 3 shown in FIG. 2. The activation procedure of the virtualization engine 10 on the thin-client server 4 is the same as that of the virtualization engine 10 on the client 3. That is, when the thin-client server 4 is activated, the first operating system (for activating the virtualization engine 10) is activated, and the virtualization engine 10 defined as a resident program is activated under the control of the first operating system.

The virtualization engine 10 running on the thin-client server 4 constructs virtual machines 20 equal in number to, for example, thin clients 5 to be managed, and constructs a virtual desktop environment on each virtual machine 20 by using image data stored in the system data database 1a of the management server 1. The virtualization engine 10 running on the thin-client server 4 transmits, to each thin client 5, image data for the GUI (for the user to log in) formed by the second operating system running on each virtual machine 20.

The thin client 5 displays the GUI by using the image data received from the thin-client server 4, and accepts the entered user ID and password. The thin client 5 transmits the entered user ID and password to the thin-client server 4. The virtualization engine 10 running on the thin-client server 4 transmits the user ID and password to the second operating system running on the virtual machine 20. The second operating system executes the login procedure including user authentication by using the user ID and password, and forms image data for the basic screen image for the corresponding user.

The virtualization engine 10 running on the thin-client server 4 transmits this image data for the basic screen image to each thin client 5. After that, the virtualization engine 10 running on the thin-client server 4 executes the process of relaying the image data and operation data between the virtual machine 20 and thin client 5. That is, the virtualization engine 10 includes a function of causing a computer in which the virtualization engine 10 is installed to operate as a server for managing a thin client, in addition to the function of causing the computer to operate as a thin client. The thin-client server processing module 14 is a module for performing this function (of causing a computer in which the module 14 is installed to operate as a server for managing a thin client).

The virtualization engine 10 must acquire user data for the login user (a virtual disk file containing the user data) from the file server 2, even when the second operating system running on each of the plurality of virtual machines 20 constructed on the thin-client server 4 forms image data for the basic screen image. Therefore, the virtualization engine 10 requests the file server 2 to first transmit the block file of the uppermost layer among a plurality of block files forming the virtual disk file to be acquired.

Upon receiving this block file of the uppermost layer, the virtualization engine 10 causes the second operating system running on the virtual machine 20 to recognize the virtual disk file (the transmission of which from the file server 2 is only partially complete) as a disk. As described previously, access for login is almost performed for data used last time, so the data exists in the uppermost layer. Therefore, the login procedure can be completed in the uppermost layer alone. That is, the information processing apparatus of this embodiment achieves efficient data transmission (data synchronization acquisition) by which data highly likely to be accessed is transmitted earlier, and data less likely to be accessed is transmitted later. This makes it possible to largely shorten the time before the thin client 5 becomes usable after the login operation.

Note that even when the user using the thin client 5 has variously updated data, the updated data exist in the thin-client server 4. Accordingly, if the user logs out from the thin client 5, this logout can immediately be completed. After the logout, data need only be synchronized for the virtual disk file between the thin-client server 4 and file server 2 (a block file in which a block containing update target data exists need only be transmitted from the thin-client server 4 to the file server 2).

As described above, the information processing apparatus (the client 3 or thin-client server 4) of this embodiment performs data transmission with the file server 2 not for each file to be recognized by an operating system or application program (running on a virtual machine) but for each block file forming a virtual disk file for a virtual disk. This achieves efficient data synchronization between the apparatus and file server 2. Accordingly, after a login operation is performed on the client 3 functioning as a thin client or on the thin client 5, it is possible to largely shorten the time before the client 3 or thin client 5 becomes usable.

A new layer is generated when a designated period (for example, one week) has elapsed, or when the block of the uppermost layer has reached the maximum value of one layer. The layer generation timing can be adjusted in accordance with the use frequency or purpose of user data.

The method of taking data synchronization for the user data unique to a user which is managed by the file server 2 has been explained above, but the system data to be managed by the management server 1 can also be a target of data synchronization. The above described method can be used to, for example, transmit the system data to a diskless thin client.

Note that the operation control process of this embodiment can be implemented by software (a program). Therefore, the same effect as that of this embodiment can easily be achieved by installing the software in an ordinary computer by using a computer readable storage medium storing the software, and executing the installed software.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a communication module; and
a virtualization engine configured to construct a virtual machine as a virtual hardware environment for running various programs comprising an operating system,
wherein the virtualization engine comprises:
a virtual disk file generation module configured to generate a virtual disk file for a virtual disk to be constructed on the virtual machine in order to manage user data unique to each user by a file server connected via the communication module and cause the operating system running on the virtual machine to recognize the user data managed by the file server as data stored in a disk on the virtual machine, the user data comprising setting information of the operating system running on the virtual machine, the virtual disk file having a data structure in which difference data is stored as a layer in time series; and
a data transmission module configured to execute data transmission in order from difference data in an upper layer which is new in time series, when taking synchronization of the user data in the virtual disk file between the file server and the virtual machine.

2. The apparatus of claim 1, wherein:
the virtualization engine further comprises a virtual disk file management module; and
when data requested as a read target from the operating system running on the virtual machine exists in a lower layer other than an uppermost layer in the virtual disk file, the virtual disk file management module copies the data to the uppermost layer.

3. The apparatus of claim 2, wherein when update target data requested as a write target from the operating system running on the virtual machine exists in the lower layer, the virtual disk file management module invalidates the update target data by attaching attribute information indicating that the data is invalidated.

4. The apparatus of claim 2, wherein when update target data requested as a write target from the operating system running on the virtual machine exists in the lower layer, the virtual disk file management module deletes the update target data from the lower layer.

5. The apparatus of claim 1, wherein the virtualization engine further comprises a thin-client server processing module configured to transmit image data of a screen image to a thin-client terminal connected via the communication module, the screen image being formed by the operating system running on the virtual machine based on the user data managed by the file server.

6. The apparatus of claim 5, wherein the thin-client server processing module transmits operation data received from the thin-client terminal to the operating system running on the virtual machine.

7. A method of processing information for an information processing apparatus which constructs a virtual machine as a virtual hardware environment for running various programs comprising an operating system, the method comprising:
generating a virtual disk file for a virtual disk to be constructed on the virtual machine in order to manage user data unique to each user by a file server connected across a network and cause the operating system running on the virtual machine to recognize the user data managed by the file server as data stored in a disk on the virtual machine, the user data comprising setting information of the operating system running on the virtual machine, the virtual disk file having a data structure in which difference data is stored as a layer in time series; and
executing data transmission in order from difference data in an upper layer which is new in time series, when taking synchronization of the user data in the virtual disk file between the file server and the virtual machine.

8. The method of claim 7, further comprising, when data requested as a read target from the operating system running on the virtual machine exists in a lower layer other than an uppermost layer in the virtual disk file, copying the data to the uppermost layer.

9. The method of claim 8, further comprising, when update target data requested as a write target from the operating system running on the virtual machine exists in the lower layer, invalidating the update target data by attaching attribute information indicating that the data is invalidated.

10. The method of claim 8, further comprising, when update target data requested as a write target from the operating system running on the virtual machine exists in the lower layer, deleting the update target data from the lower layer.

11. The method of claim 6, further comprising transmitting image data of a screen image to a thin-client terminal connected across a network, the screen image being formed by the operating system running on the virtual machine based on the user data managed by the file server.

12. The method of claim 11, further comprising transmitting operation data received from the thin-client terminal to the operating system running on the virtual machine.

13. A computer-readable, non-transitory storage medium having stored thereon a computer program which is executable by a computer, the computer program controlling the computer to executions of:
causing the computer to operate as a virtualization engine configured to construct a virtual machine as a virtual hardware environment for running various programs including an operating system,
wherein the virtualization engine comprises:
a virtual disk file generation module configured to generate a virtual disk file for a virtual disk to be constructed on the virtual machine in order to manage user data unique to each user by a file server connected across a network and cause the operating system running on the virtual machine to recognize the user data managed by the file server as data stored in a disk on the virtual machine, the user data comprising setting information of the operating system running on the virtual machine, the virtual disk file having a data structure in which difference data is stored as a layer in time series; and
a data transmission module configured to execute data transmission in order from difference data in an upper layer which is new in time series, when taking synchronization of the user data in the virtual disk file between the file server and the virtual machine.

14. The medium of claim 13, wherein:
the virtualization engine further comprises a virtual disk file management module; and
when data requested as a read target from the operating system running on the virtual machine exists in a lower layer other than an uppermost layer in the virtual disk file, the virtual disk file management module copies the data to the uppermost layer.

15. The medium of claim 14, wherein when update target data requested as a write target from the operating system running on the virtual machine exists in the lower layer, the virtual disk file management module invalidates the update target data by attaching attribute information indicating that the data is invalidated.

16. The medium of claim 14, wherein when update target data requested as a write target from the operating system running on the virtual machine exists in the lower layer, the virtual disk file management module deletes the update target data from the lower layer.

17. The medium of claim 13, wherein the virtualization engine further comprises a thin-client server processing module configured to transmit image data of a screen image to a thin-client terminal connected via the communication module, the screen image being formed by the operating system running on the virtual machine based on the user data managed by the file server.

18. The medium of claim 17, wherein the thin-client server processing module transmits operation data received from the thin-client terminal to the operating system running on the virtual machine.
